(19) United States
(12) Patent Application Publication
(10) Pub. No.: US 2009/0303747 A1
(43) Pub. Date: Dec. 10, 2009

(54) HEAT DISSIPATING STRUCTURE OF BACKLIGHT MODULE

(75) Inventor: Tsan-Jung Chen, Sanchong City (TW)

Correspondence Address: BACON & THOMAS, PLLC, 625 SLATERS LANE, FOURTH FLOOR, ALEXANDRIA, VA, 22314-1176, US

(73) Assignee: KOCAM INTERNATIONAL CO., LTD., Sanchong City (TW)

(21) Appl. No.: 12/232,506

(22) Filed: Sep. 18, 2008

(30) Foreign Application Priority Data
Jun. 9, 2008 (TW) 097210133

(51) Int. Cl. F21V 7/04

(52) U.S. Cl. 362/633

(57) ABSTRACT

A heat dissipating structure of a backlight module includes two light emitting portions and a backlight portion having a light guide plate, a back reflector and a metal clad. The light guide plate is connected to the back reflector. A dent is formed and attached to the light guide plate. The back reflector is connected to the metal clad. Each light emitting portion includes a metal cover, a lamp cup reflector, at least one lamp tube and lamp holders. The lamp cup reflector is attached to the metal cover. A containing groove is formed at the lamp cup reflector and contains the lamp tubes and lamp holders. A thermal conducting plate is extended from the metal cover and contacted with the metal clad. Thus, the heat produced by the lamp tube can be conducted to the metal clad through the lamp holder and the metal cover for heat dissipation.

### FIELD OF THE INVENTION

The present invention relates to a heat dissipating structure, and more particularly to a heat dissipating structure of a backlight module.

### BACKGROUND OF THE INVENTION

Traditional display products (such as televisions and monitors) adopt a cathode ray tube (CRT) for the image display effect, but a CRT monitor generally comes with a heavy weight and consumes much power, and thus the traditional CRT monitor is gradually substituted by a liquid crystal display (LCD) panel. Compared with the CRT products, the LCD panel product (such as a notebook computer, a monitor and a television) has a lighter, thinner, shorter and smaller design, so that users can carry or transport the LCD products easily and do not require much space for placing the products, and such LCD products can maximize the utility of space effectively. In recent years, the LCD products become increasingly popular for both individual and corporate users and extensively used in our daily life and work.

In general, LCD panels display an image by passing a light from the back side of the LCD panel into a liquid crystal layer and then transmitting the light and image through liquid crystals to the front side of LCD panel. Since the liquid crystal is not a light emitting material, the LCD panel has to project the light from the back side to the front side of the LCD panel by a backlight module to provide sufficient brightness and a uniform light source to the liquid crystals, so that the image produced by the liquid crystals can be displayed properly at the front side of the LCD panel. In general, most present backlight modules adopt an edge lighting structure. With reference to FIG. 1 for a traditional edge lighting structured backlight module 1, the structure comprises a backlight portion 10, two light emitting portions 12 and a back panel 14, wherein the back panel 14 has a U-shaped cross section, and the backlight portion 10 includes a light guide plate 100 and a back reflector 102, and the back side of the light guide plate 100 is coupled to the front side of the back reflector 102. Further, the two light emitting portions 12 individually comprise a metal cover 120, a lamp cup reflector 122, a lamp tube 124 and two lamp holders 126, wherein a side of the lamp cup reflector 122 is attached onto an internal side of the metal cover 120 by a glue 1221, and a containing groove 123 is concavely disposed on another side of the lamp cup reflector 122 for containing the lamp tube 124 and the two lamp holders 126. The two lamp holders 126 are coupled to both ends of the lamp tube 124, such that the lamp tube 124 is not in contact with the lamp cup reflector 122, and the lamp cup reflector 122 can completely reflect a light source produced by the lamp tube 124. In addition, the two light emitting portions 12 are installed on both corresponding sides of the backlight portion 10 respectively, and the openings of the two containing groove 123 face towards both corresponding sides of the light guide plate 100, and then the backlight portion 10 and the two light emitting portions 12 are installed onto the back panel 14, such that both corresponding internal sides of the back panel 14 abut the external sides of the two metal covers 120 respectively, and the backlight portion 10 can be engaged closely with the two light emitting portions 12. As a result, the light source produced by the lamp tube 124 can be reflected directly from the corresponding lamp cup reflectors 122 into both corresponding sides of the light guide plate 100, and refracted by the back reflector 102 to the front side-of the light guide plate 100.

With reference to FIG. 2 (for simplicity, only one of the light emitting portions 12 is shown), a large quantity of heat is produced and conducted to the two lamp holders 126 when the lamp tube 124 starts emitting light. Now, the two lamp holders 126 will conduct the heat to the back panel 14 through the lamp cup reflector 122 and the metal cover 120 sequentially. Since the back panel 14 is made of metal and comes with a larger area, therefore the heat can be dissipated quickly to reduce the total heat quantity of the backlight module 1 effectively and extend the life of the backlight module 1. In recent years, the material cost rises, and manufacturers bear a higher production cost while maintaining a specific volume of sales, and thus many panel manufacturers make changes to the structure of the backlight module 1 in order to lower the cost. Some manufacturers remove the back panel 14 from the traditional backlight module 1 and install the backlight portion 10 and the light emitting portion 12 into a casing directly, but the structure of this sort has a heat dissipation issue. In FIG. 2, the backlight module 1 no longer includes a back panel 14, and thus the heat accumulated in the lamp holder 126 can be dissipated through the metal cover 120 only. Since the area of the metal cover 120 is very limited, and the lamp cup reflector 122 is installed between the metal cover 120 and the lamp holder 126, therefore the overall heat dissipating effect of the backlight module is poor. When panel manufacturers increase the quantity of lamp tubes 124 at the light emitting portion 12 to meet the requirements of a design, the metal cover 120 cannot dissipate heat fast enough to meet the requirement, and the heat produced by the lamp tubes 124 is accumulated at the light emitting portion 12, so that the lamp tube 124 and the light guide plate 100 next to the light emitting portion 12 will be deteriorated easily, and the life of the backlight module 1 will be shortened. Therefore, it is an important subject for panel designers and manufacturers to design and develop a heat dissipating structure applied to a backlight module to overcome the foregoing shortcomings of the prior art.

### SUMMARY OF THE INVENTION

In view of the shortcomings of the traditional backlight modules that dissipate heat through the back panel, but most manufacturers remove the back panel of the backlight module for a cost down purpose, and the backlight module will have difficulties to dissipate heat and cause a deterioration of components easily, the inventor of the present invention based on years of experience in the related industry to conduct extensive researches and experiments, and finally developed a heat dissipating structure of a backlight module in accordance with the present invention to overcome the shortcomings of the prior art.

Therefore, it is a primary objective of the present invention to provide a heat dissipating structure of a backlight module, and the structure comprises two light emitting portions and a backlight portion, wherein the backlight portion includes a light guide plate, a back reflector and a metal clad, and the back side of the light guide plate is coupled to the front side of the back reflector, and two first protruding portions are extended from both sides of the back reflector respectively, and a dent is formed between two first protruding portions on either side, and the first protruding portions are bent upward and attached onto two corresponding sides of the light guide plate, and the back side of the back reflector is coupled to the front side of the metal clad by a first adhesive layer, and two second protruding portions corresponding to the positions of the first protruding portions are protruded from both corresponding sides of the metal clad respectively, and the second protruding portions are bent upward and attached onto the first protruding portions. Further, the two light emitting portions individually comprise a metal cover, a lamp cup reflector, at least one lamp tube and a plurality of lamp holders, wherein a side of the lamp cup reflector is attached onto an internal side of the metal cover by a glue, and a containing groove is concavely disposed on another side of the lamp cup reflector. The containing groove contains at least one lamp tube and a plurality of lamp holders, and the lamp holders are coupled to both ends of the lamp tube, such that the lamp tube is not in contact with the lamp cup reflector. In addition, the two light emitting portions are installed on both corresponding sides of the backlight portion, and openings of the containing grooves face two corresponding sides of the backlight portion, such that the second protruding portions can be in contact with the lamp holders, and the lamp tube is aligned with the dent, and a thermal conducting plate is extended from a side of the metal cover and proximate to the back reflector, and the thermal conducting plate is in contact with the back side of the metal clad. As a result, the heat produced by the lamp tube can be conducted to the metal clad through the lamp holder and the metal cover for dissipating the heat quickly and extending the life of the backlight module.

Another objective of the present invention is to provide a heat dissipating structure of a backlight module, and the heat dissipating structure comprises two light emitting portions and a backlight portion, and the two light emitting portions are installed onto both corresponding sides of the backlight portion respectively, wherein the two light emitting portions individually comprise a metal cover, a lamp cup reflector, at least one lamp tube and a plurality of lamp holders, and a side of the lamp cup reflector is attached onto an internal side of the metal cover, and a containing groove is concavely disposed on another side of the lamp cup reflector, and the containing groove contains at least one lamp tube and a plurality of lamp holders. The lamp holders are coupled to both ends of the lamp tube, such that the lamp cup reflector can completely reflect the light source emitted from the lamp tube. Further, the backlight portion comprises a light guide plate, a back reflector and a metal clad, and the back side of the light guide plate is attached to the front side of the back reflector. The back side of the back reflector includes a first adhesive layer for attaching the front side of the metal clad, and two protruding portions are extended from both sides of the metal clad respectively. The protruding portions are bent upward and attached onto both corresponding sides of the light guide plate, and a dent is formed between two protruding portions on either side. Further, the openings of the containing grooves of the two light emitting portions face the backlight portion, such that the protruding portions can be in contact with the lamp holders, and the lamp tube is aligned with the dent, and a thermal conducting plate is extended from a side of the metal cover proximate to the back reflector, and the thermal conducting plate is in contact with the back side of the metal clad. Therefore, the heat at the lamp holders can be conducted directly to the metal clad or conducted to the metal clad through the metal cover to achieve a quick heat dissipating effect to prevent overheat of the light emitting portion and deterioration of the components of the backlight module.

A further objective of the present invention is to provide a metal clad with a larger area and design a protruding portion disposed on the metal clad for attaching the lamp holder directly, so that the heat at the lamp holders can be conducted quickly to the back side of the metal clad for heat dissipation, so as to reduce the total heat quantity of the lamp holders effectively. Further, the heat at a side of the lamp holder away from the protruding portion is conducted to the metal cover. Since the thermal conductivity effect of the metal clad is superior to the thermal conductivity effect of the metal cover, therefore the heat at the metal cover can be conducted to the back side of the metal clad through the thermal conducting plate and dispersed into the air to achieve the effect of dissipating a large quantity of heat quickly. The backlight module of the invention can maintain a high heat dissipating performance without a back panel. In addition, the thickness of the metal clad is smaller than the thickness of the back panel, and thus the material consumption of the metal clad is less than that of the back panel, and manufacturers can lower the production cost.

To make it easier for our examiner to understand the shape, structure, design principle and performance of the present invention, we use preferred embodiments together with the attached drawings for the detailed description of the invention as follows:

### BRIEF DESCRIPTION OF THE DRAWINGS

FIG. 1 is a schematic view of a conventional backlight module;

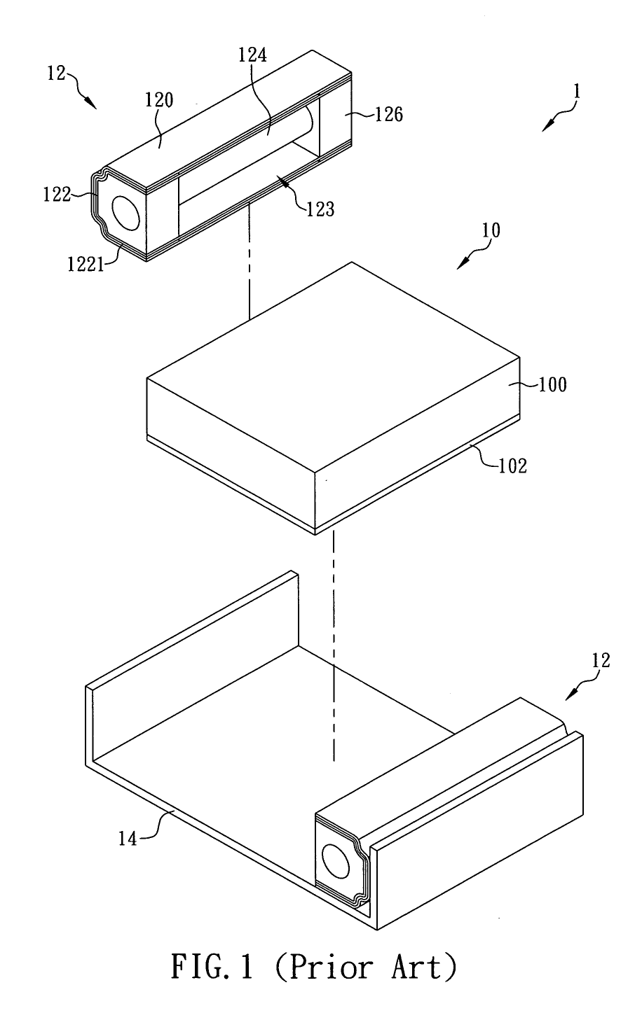

FIG. 2 is a cross-sectional view of a conventional backlight module;

FIG. 3 is a schematic view of a preferred embodiment of the present invention;

FIG. 4 is a cross-sectional view of a preferred embodiment of the present invention;

FIG. 5 is a schematic view of another preferred embodiment of the present invention; and

FIG. 6 is a cross-sectional view of another preferred embodiment of the present invention.

### DETAILED DESCRIPTION OF THE PREFERRED EMBODIMENTS

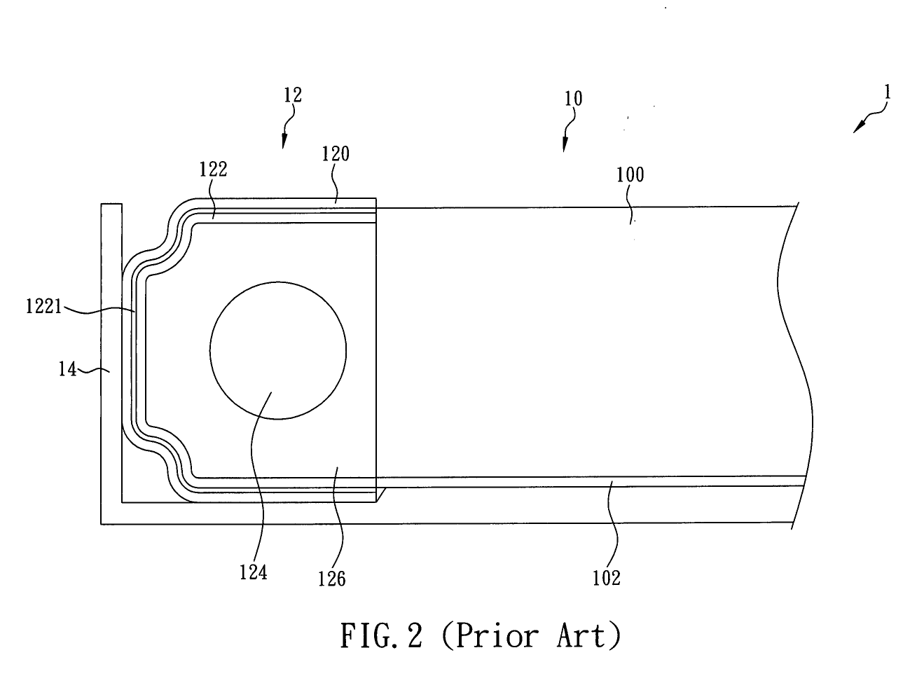

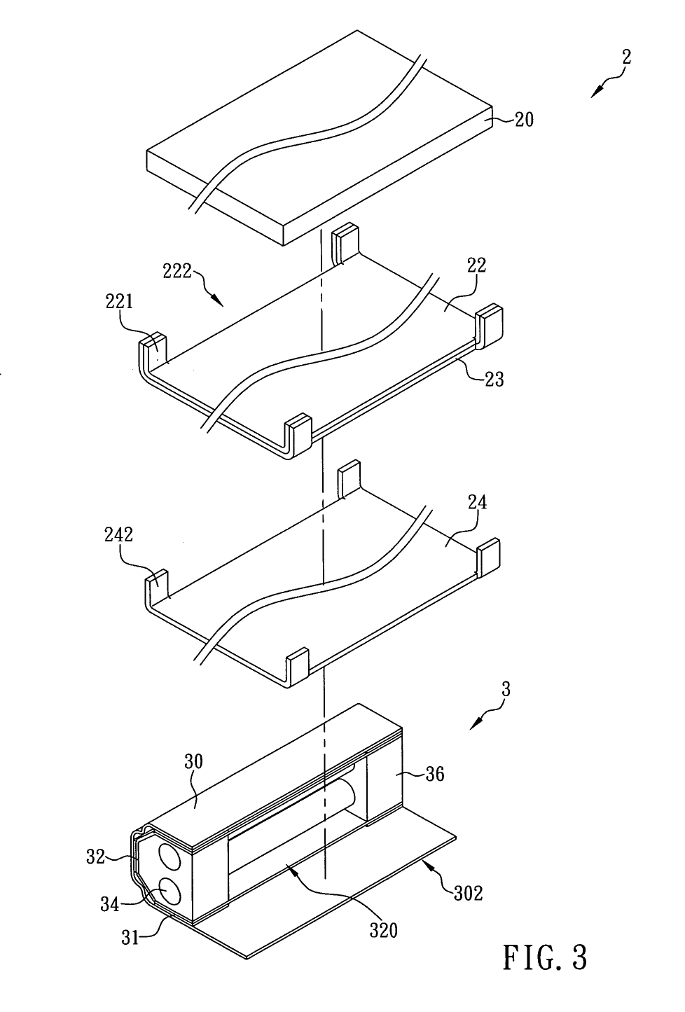

With reference to FIG. 2 for a heat dissipating structure of a backlight module in accordance with the present invention, the backlight module comprises a backlight portion and two light emitting portions. In a preferred embodiment of the present invention as shown in FIG. 3 (for simplicity, only one of the light emitting portion 3 is shown), the backlight portion 2 comprises a light guide plate 20, a back reflector 22 and a metal clad 24, wherein the back side of the light guide plate 20 is coupled to the front side of the back reflector 22, so that when the light source entered into the light guide plate 20 is refracted to the back side of the light guide plate 20, the light source can be reflected to the front side of the light guide plate 20. Further two first protruding portions 221 are extended from both sides of the back reflector 22 respectively, and a dent 222 is formed between two first protruding portions 221 on either side, and the first protruding portions 221 are bent upward and attached onto both corresponding sides of the light guide plate 20. A first adhesive layer 23 is disposed on the back side of the back reflector 22, such that the back side of the back reflector 22 is coupled to the front side of the metal clad 24 through the first adhesive layer 23, and two second protruding portions 242 are extended from both sides of the metal clad 24 corresponding to the positions of the first protruding portions 221 respectively, and the second protruding portions 242 are bent upward and attached onto the first protruding portions 221. The two light emitting portions 3 individually comprise a metal cover 30, a lamp cup reflector 32, at least one lamp tube 34 and a plurality of lamp holders 36. In this preferred embodiment, a light emitting portion 3 includes two lamp tubes 34 and two lamp holder 36, wherein the lamp cup reflector 32 has a cross section substantially in the same shape of the cross section of the metal cover 30, and a side of the two lamp cup reflectors 32 is attached to an internal side of the metal cover 30 by a glue 31, and a containing groove 320 is disposed concavely on another side of the lamp cup reflectors 32. The containing groove 320 contains two lamp tubes 34 and two lamp holders 36, and the lamp holders 36 include two penetrating holes respectively, such that the lamp holders 36 can be coupled to both ends of the lamp tubes 34, and the lamp tubes 34 are not in contact with the lamp cup reflector 32 to prevent a portion of the lamp tube 34 in contact with the lamp cup reflector 32 being unable of completely reflecting the light source emitted from the lamp tube 34 or adversely affecting the overall reflection efficiency.

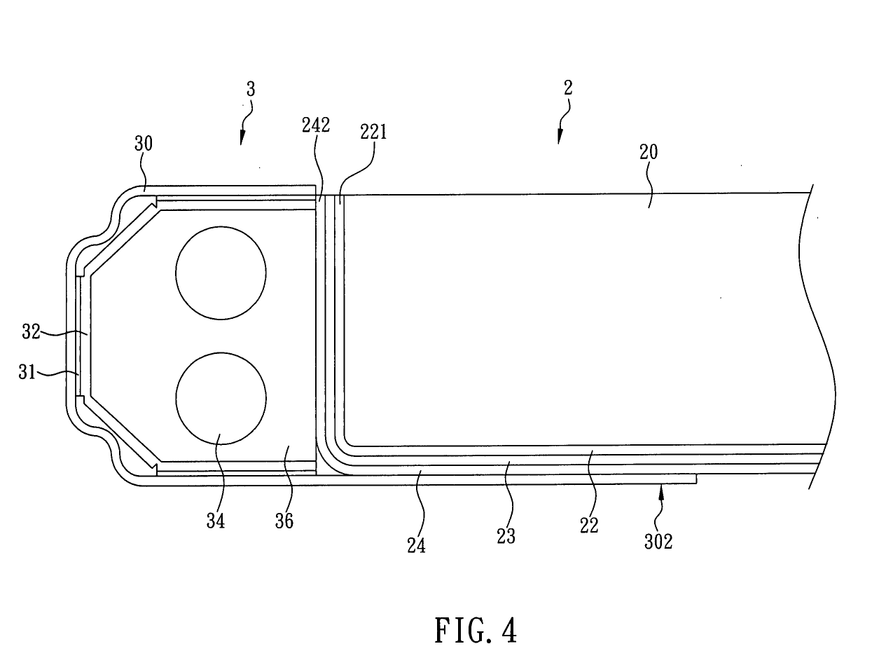

With reference to FIGS. 3 and 4, the two light emitting portions 3 are installed onto both sides of the backlight portion 2 respectively (for simplicity, only one of the light emitting portions 3 is shown), and openings of the containing grooves 320 of the two light emitting portions 3 face both sides of the backlight portion 2 respectively, such that the second protruding portions 242 can be in contact with the lamp holders 36 respectively, and the lamp tube 34 is aligned with the dent 222. Therefore, the light source emitted from the lamp tube 34 can be entered into the light guide plate 20 through the dent 222 and reflected and refracted to provide a uniform light source at the front side of the light guide plate 20. Since the lamp holders 36 are directly in contact with the second protruding portions 242, and the thermal conductivity effect of the metal clad 24 is superior to the thermal conductivity effect of the lamp holders 36, therefore the heat of the lamp holders 36 can be conducted directly to the metal clad 24 through the second protruding portions 242 for heat dissipation. A thermal conducting plate 302 is extended from a side of the metal cover 30 proximate to the back reflector 22, and the thermal conducting plate 302 is in contact with the back side of the metal clad 24. It is noteworthy to point out that the thermal conductivity effect of the metal clad 24 is superior to the thermal conductivity effect of the metal cover 30, and thus the heat at the metal cover 30 can be conducted quickly from the thermal conducting plate 302 to the metal clad 24 for heat dissipation. As a result, the heat produced by the lamp tube 34 can be conducted from the lamp holder 36 on both ends of the lamp tube 34 and the metal cover 30 to the metal clad 24. Since the metal clad 24 has a larger area and a better heat dissipating effect, the heat at the metal clad 24 can be dissipated quickly to prevent the heat produced by the lamp tube 34 from accumulating at the lamp holder 36, which will deteriorate the components adjacent to the lamp holders 36, and the heat dissipating structure of the present invention can enhance the life of backlight module effectively.

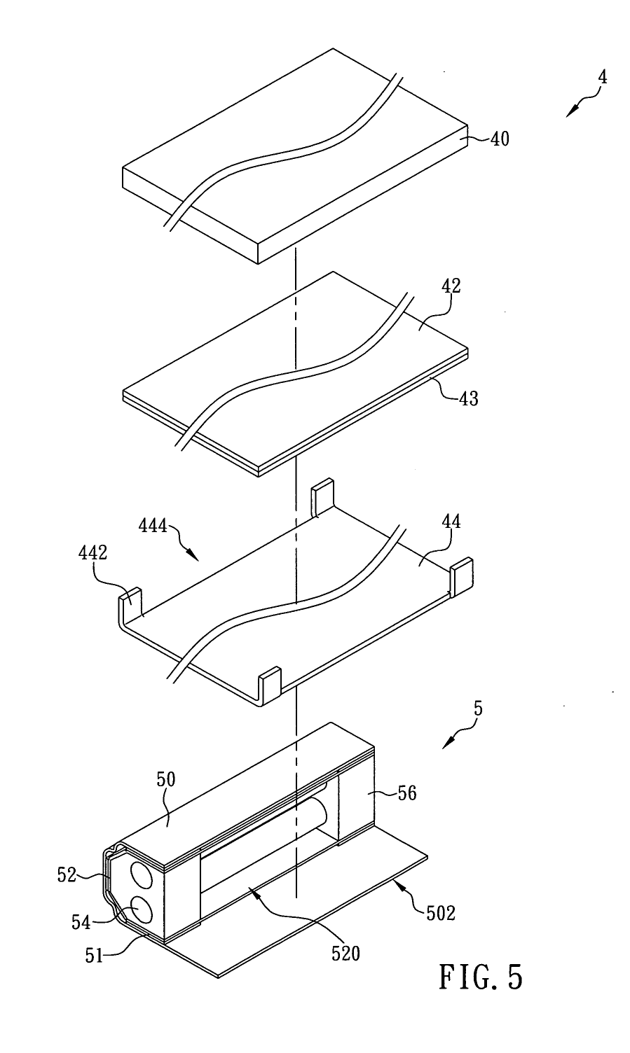

With reference to FIG. 5 for another preferred embodiment of the present invention, the backlight module comprises a backlight portion 4 and two light emitting portions 5 (for simplicity, only one of the light emitting portions 5 is shown), and the two light emitting portions 5 are installed on both corresponding sides of the backlight portion 4 respectively. The backlight portion 4 includes a light guide plate 40, a back reflector 42 and a metal clad 44, and the back side of the light guide plate 40 is coupled to the front side of the back reflector 42, and the back side of the back reflector 42 is coupled to the front side of the metal clad 44 through a first adhesive layer 43. Further, two protruding portions 442 are extended from both sides of the metal clad 44 respectively, and a dent 444 is formed between two protruding portions 442 on either side, and the protruding portions 442 is bent upward and attached onto both corresponding sides of the light guide plate 40. Further, the two light emitting portions 5 individually comprise a metal cover 50, a lamp cup reflector 52, at least one lamp tube 54 and a plurality of lamp holders 56. In another preferred embodiment, a light emitting portion 5 includes two lamp tubes 54 and two lamp holders 56, and a side of the lamp cup reflector 52 is attached onto an internal side of the metal cover 50 away from the backlight portion 4 by a glue 51, and a containing groove 520 is concavely disposed on another side of the lamp cup reflector 52, and a lamp holder 56 is coupled to both ends of the two lamp tubes 54. The lamp tubes 54 and the lamp holder 56 are contained into the containing groove 520, such that the lamp tubes 54 are not in contact with the lamp cup reflector 52 to prevent lowering the reflection efficiency of the lamp cup reflector 52.

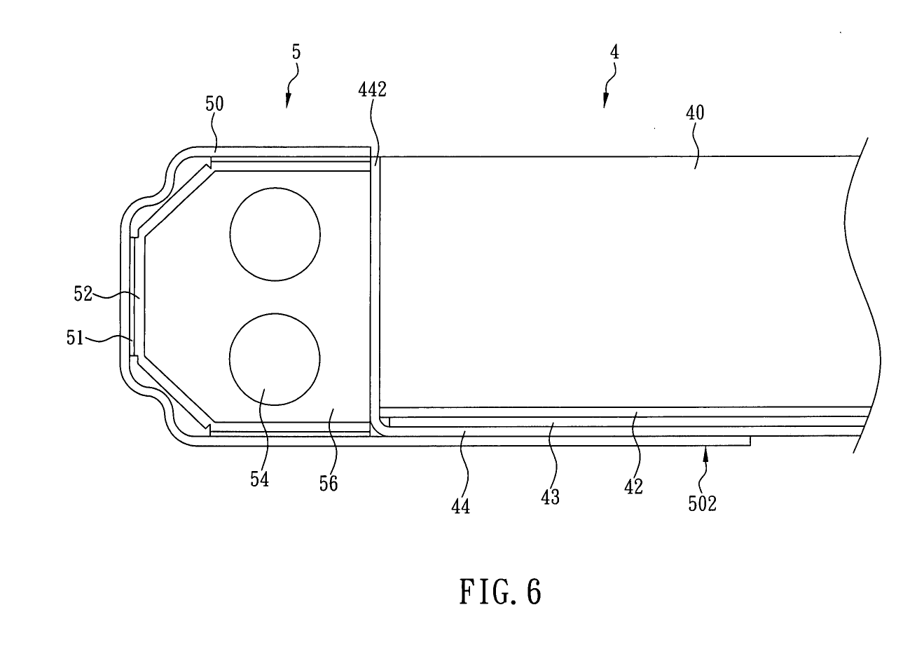

With reference to FIGS. 5 and 6, the lamp tube 54 of the light emitting portion 5 is aligned with the dent 444 of the backlight portion 4, such that the light source emitted from the lamp tube 54 can be passed into the light guide plate 40 through the dent 444, and the protruding portions 442 are attached onto the lamp holders 56 for conducting the heat produced by the lamp tubes 54 to the metal clad 44 through the lamp holders 56. Further, a thermal conducting plate 502 is extended from a side of the metal cover 50 proximate to the back reflector 42, and the thermal conducting plate 502 is attached onto the back side of the metal clad 44, such that the heat at the metal cover 50 is conducted from the thermal conducting plate 502 to the metal clad 44. Since the thermal conductivity effect of the metal clad 44 is superior to the thermal conductivity effect of the lamp holder 56 and the metal cover 50, and the metal clad 44 has a larger area than the area of the lamp holder 56 and the metal cover 50, and thus the heat dissipating speed of the metal clad 44 is higher than the heat dissipating speed of the lamp holder 56 and the metal cover 50, and a temperature difference between the metal clad 44 and the lamp holder 56 or the metal cover 50 is produced to conduct the heat at the lamp holder 56 and the metal cover 50 to the metal clad 44 and dissipating the heat from the metal clad 44 continuously. Thus, the present invention can reduce the total heat quantity of the backlight module to extend the life of the backlight module.

In the foregoing preferred embodiment, the lamp holder is made of silicone or an elastic material, so that the lamp holder can fit in different shapes of the containing groove, and the quantity of penetrating holes on the lamp holder can be one or more as required for connecting an end of a lamp tube or ends of a plurality of lamp tubes. The backlight module of the present invention is installed directly in the casing, and the external side of the metal cover abuts the casing directly, such that the light emitting portion and the backlight portion are pressed with each other, and the light emitting portion and the backlight portion can be attached with each other without using a glue, and the heat at the lamp holder can be conducted directly to the metal clad. With the heat dissipating structure of the present invention, a good heat dissipating effect of the backlight module can be maintained even if the back panel is removed, and thus the production cost can be lowered.

While the invention has been described by means of specific embodiments, numerous modifications and variations could be made thereto by those skilled in the art without departing from the scope and spirit of the invention set forth in the claims.

What is claimed is:

1. A heat dissipating structure of a backlight module, comprising:
a backlight portion, comprising:
a light guide plate;
a back reflector, with a front side coupled to a back side of the light guide plate, and two first protruding portions being extended from both corresponding sides of the back reflector respectively, and a dent being formed on a side of either one of the two first protruding portions, and the first protruding portions being bent upward and attached onto both corresponding sides of the light guide plate respectively, and the back side of the back reflector having a first adhesive layer; and
a metal clad, with a front side coupled to the back reflector by the first adhesive layer, and two second protruding portions being extended from both sides of the metal clad and corresponding to positions of the first protruding portions respectively, and the second protruding portions being bent upward and attached onto the first protruding portions; and
two light emitting portions, installed on both corresponding sides of the backlight portion respectively, and each comprising:
a lamp cup reflector, having a containing groove concavely disposed on a side of the light emitting portions, and an opening of the containing groove facing the backlight portion;
at least one lamp tube;
a plurality of lamp holders, having at least one penetrating hole disposed thereon, and the lamp holders being coupled to both ends of the lamp tube, and contacted with the second protruding portions respectively, such that the lamp tube is aligned with the dent; and
a metal cover, with an internal side attached onto another side of the lamp cup reflector away from the backlight portion by a glue, and a thermal conducting plate being extended from a side of the metal cover proximate to the back reflector and contacted with a back side of the metal clad.

2. The heat dissipating structure of a backlight module as recited in claim 1, wherein the metal clad has a thermal conductivity effect superior to the thermal conductivity effect of the lamp holder and the metal cover.

3. The heat dissipating structure of a backlight module as recited in claim 2, wherein the lamp holder is made of a silicone material.

4. A heat dissipating structure of a backlight module, comprising:
a backlight portion, comprising:
a light guide plate;
a back reflector, with a front side coupled to a back side of the light guide plate, and the back side of the back reflector having a first adhesive layer; and
a metal clad, with a front side coupled to the back reflector by the first adhesive layer, and two protruding portions being extended from both sides of the metal clad respectively, and a dent being formed between the two protruding portions on either side, and the protruding portions being bent upward and attached onto both corresponding sides of the light guide plate; and
two light emitting portions, installed on both corresponding sides of the backlight portion respectively, and each comprising:
a lamp cup reflector, having a containing groove concavely disposed on a side of the light emitting portions, and an opening of the containing groove facing the backlight portion;
at least one lamp tube;
a plurality of lamp holders, having at least one penetrating hole disposed thereon, and the lamp holders being coupled to both ends of the lamp tube, and contacted with the second protruding portions respectively, such that the lamp tube is aligned with the dent; and
a metal cover, with an internal side attached onto another-side of the lamp cup reflector away from the backlight portion by a glue, and a thermal conducting plate being extended from a side of the metal cover proximate to the back reflector and contacted with a back side of the metal clad.

5. The heat dissipating structure of a backlight module as recited in claim 4, wherein the metal clad has a thermal conductivity effect superior to the thermal conductivity effect of the lamp holder and metal cover.

6. The heat dissipating structure of a backlight module as recited in claim 5, wherein the lamp holder is made of a silicone material.
